(19) United States
(12) Patent Application Publication
(10) Pub. No.: US 2021/0358152 A1
(43) Pub. Date: Nov. 18, 2021

(54) MONITORING DISTANCES BETWEEN PEOPLE

(71) Applicant: CORSIGHT .AI, Tel Aviv (IL)

(72) Inventor: Karina ODINAEV, Tel Aviv (IL)

(73) Assignee: CORSIGHT .AL, Tel Aviv (IL)

(21) Appl. No.: 17/302,701

(22) Filed: May 11, 2021

Related U.S. Application Data
(60) Provisional application No. 63/023,773, filed on May 12, 2020.

(51) Int. Cl. G06T 7/536; G06K 9/00; G06T 7/60; G06T 7/70; G06T 7/20; G06K 9/62; G06F 16/9535

(52) U.S. Cl. CPC G06T 7/536; G06K 9/00228; G06T 7/60; G06T 7/70; G06T 7/20; G06T 2207/30232; G06K 9/00771; G06F 16/9535; G06T 2207/30201; G06T 2207/20081; G06K 9/6215

(57) ABSTRACT

Systems, and method and computer readable media that store instructions for face based distance measurements related to pandemic avoidance instructions compliance.

### BACKGROUND

Pandemic avoidance instructions may dictate that certain distances should be maintained between adjacent persons. The Pandemic avoidance instructions may also indicate predefined periods of time in which the distances should be maintained. For example—some pandemic avoidance instructions dictate that the minimal distance between adjacent persons is at least 2 meters.

The pandemic avoidance instructions must be applied by vast number of persons and manual enforcement is not practical and very inaccurate.

There is a growing need to provide an efficient and cost effective solution for monitoring the compliance of pandemic avoidance instructions.

### SUMMARY

There may be provided systems, methods and computer readable medium as illustrated in the specification.

### BRIEF DESCRIPTION OF THE DRAWINGS

The embodiments of the disclosure will be understood and appreciated more fully from the following detailed description, taken in conjunction with the drawings in which:

FIG. 1 illustrates an example of a method;

FIG. 2 illustrates an example of a method;

FIG. 3 illustrates an example of a computerized device;

FIG. 4 illustrates an example of a scene;

FIG. 5 illustrates an example of a scene;

FIG. 6 illustrates an example of a scene;

FIG. 7 illustrates an example of a scene; and

FIG. 8 illustrates an example of a scene.

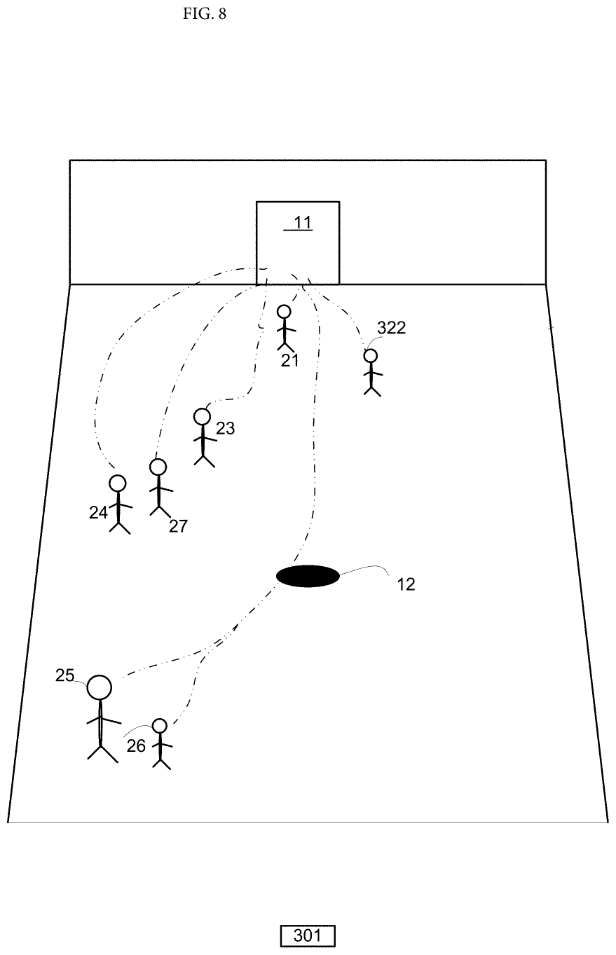

### DESCRIPTION OF EXAMPLE EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a device or system capable of executing the method and/or to a non-transitory computer readable medium that stores instructions for executing the method.

Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

Any combination of any module or unit listed in any of the figures, any part of the specification and/or any claims may be provided.

The specification and/or drawings may refer to an image. An image is an example of a media unit. Any reference to an image may be applied mutatis mutandis to a media unit. A media unit may be an example of sensed information unit. Any reference to a media unit may be applied mutatis mutandis to sensed information. The sensed information may be sensed by any type of sensors—such as a visual light camera, or a sensor that may sense infrared, radar imagery, ultrasound, electro-optics, radiography, LIDAR (light detection and ranging), etc.

The specification and/or drawings may refer to a processor. The processor may be a processing circuitry. The processing circuitry may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

Any combination of any steps of any method illustrated in the specification and/or drawings may be provided.

Any combination of any subject matter of any of claims may be provided.

Any combinations of systems, units, components, processors, sensors, illustrated in the specification and/or drawings may be provided.

The analysis of content of a media unit may be executed by generating a signature of the media unit and by comparing the signature to reference signatures. The reference signatures may be arranged in one or more concept structures or may be arranged in any other manner. The signatures may be used for object detection or for any other use.

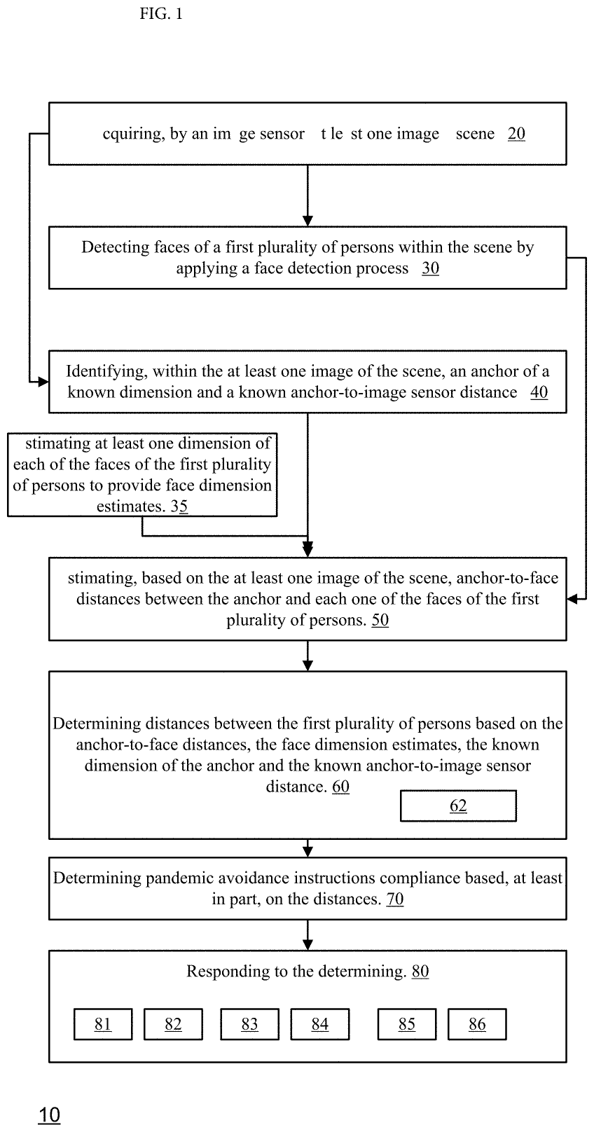

FIG. 1 illustrates an example of method 10.

Method 10 may be for face based distance measurements related to Pandemic avoidance instructions compliance.

Method 10 may start by step 20 of acquiring, by an image sensor, at least one image a scene.

The at least one image may be a video stream, some of the images of a video stream, images obtained in a continuous or non-continuous manner.

Step 20 may be followed by step 30 of detecting faces of a first plurality of persons within the scene by applying a face detection process.

The face detection process may detect the presence of the face in the image but does not need to identify the face—link the face to a specific person.

The face detection process may or may not provide some indication regarding the age (for example—baby, child, youth, or grown up) and/or gender of the person, and the like. The indication may be a rough estimate that may assist in estimating the possible or probable dimensions of the face.

Step 20 may also be followed by step 40 of identifying, within the at least one image of the scene, an anchor of a known dimension and a known anchor-to-image sensor distance.

The known dimension and/or the known anchor-to-image sensor distance may be fed to method 10 in any manner. For example the known dimension and/or the known anchor-to-image sensor distance may be measured in any manner.

Step 30 and/or 40 or any object related identification and/or any movement analysis can be done in various manners—by applying a deep neural network, by applying a machine learning process, by generating signatures of the images, by face recognition algorithms, and the like. An example of a signature generation process and/or object detection is illustrated in U.S. patent application Ser. No. 16/542,327 which is incorporated herein by reference.

Steps 30 and 40 may be followed by step 50 of estimating, based on the at least one image of the scene, anchor-to-face distances between the anchor and each one of the faces of the first plurality of persons.

The anchor-to-face distance (also referred to as a horizontal distance) may be measured, for example by determining the number of pixels between the anchor and each face. This may also take into account the relationship between the appearance of the anchor in the image (for example the number of pixels over the width of the anchor or over the length of the anchor) and the distance (for example number of pixels between) the anchor and each face.

Method 10 may also include step 35 of estimating at least one dimension of each of the faces of the first plurality of persons to provide face dimension estimates. The estimation may be based on average or expected size of faces—and if the image detection also provides an indication regarding the gender and/or ager of the person—than the estimate may take into account the gender and/or age of the person. For example—it may be assumed what is the average width of a face and/or an average length of a face of an adult and what is the average width of a face and/or an average length of a face of an adult. The amount of pixels captures in a relative dimension (size and/or length) and/or area of the face may provide an indication of the distance (vertical distance) to the image sensor.

Step 35 may include performing an estimate based on a dimension of a mask worn by a person—especially masks that are of a fixed size. Foldable masks such as surgical masks that can be unfolded to various size may processed to estimate a fixed size such as the width of the mask.

Steps 35 and 50 may be followed by step 60 of determining distances between the first plurality of persons based on the anchor-to-face distances, the face dimension estimates, the known dimension of the anchor and the known anchor-to-image sensor distance.

Step 60 may include step 62 of estimating a location of each face of the first plurality of persons based on a location of the image sensor, the anchor-to-image sensor distance, and the anchor-to-face distance of each face of the first plurality of persons.

Step 60 may include calculating the relationship, for each person having its face detected, between a virtual triangle having edges located at the position of the image sensor, at the location of the anchor (distant by an anchor-to-image sensor distance from the image sensor) and the estimated location of the face (based at least on the anchor-to-face distance).

The virtual triangles may be compared to each other to generate the distance between persons within the scene.

Step 60 may be followed by step 70 of determining pandemic avoidance instructions compliance based, at least in part, on the distances.

Step 70 may be followed by step 80 of responding to the determining.

The at least one dimension of each of the faces may be an area of each of the faces, and the known dimension of the anchor may be an area of the anchor.

At least some of the steps of method 10 (for example estimating of the anchor-to-face distances and the determining of the distances between the first plurality of persons) may be performed by applying a machine learning process, and the like.

The machine learning process may be trained with images of scenes with known locations of various people, to estimate the distance based on the faces sizes and locations.

It should be noted that method 10 may be applied with multiple anchors per scene. In this case the distance of each face from one or more of the multiple anchors may be measured. More anchoes may provide a more accurate estimation of distances between persons.

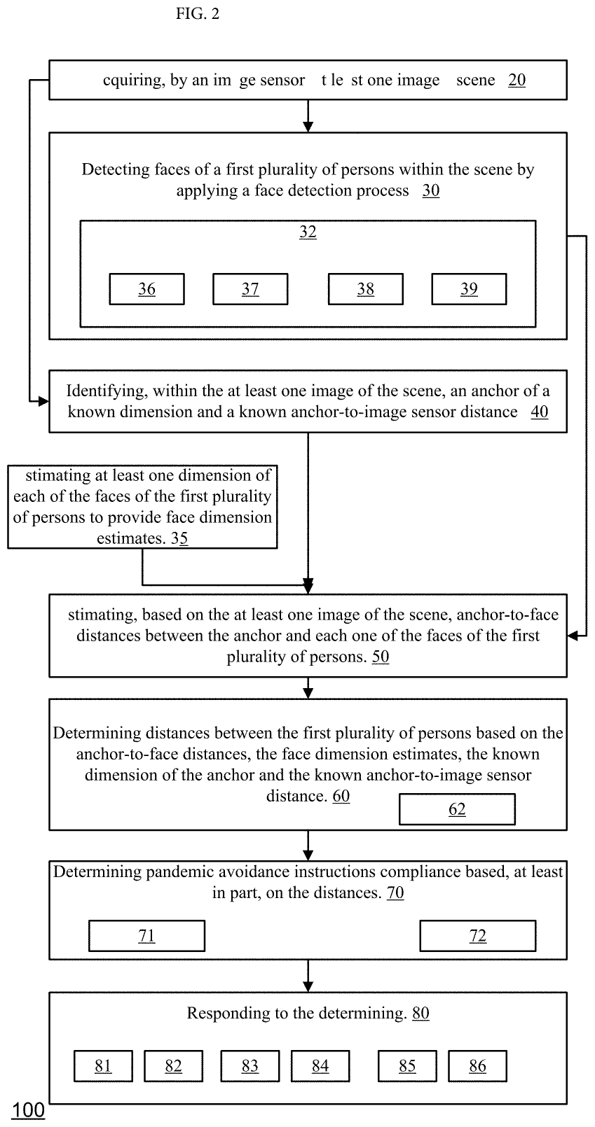

FIG. 2 illustrates an example of method 100.

Method 100 may be for face based distance measurements related to Pandemic avoidance instructions compliance.

Method 100 may start by step 20 of acquiring, by an image sensor, at least one image a scene.

Step 20 may be followed by step 30 of detecting faces of a first plurality of persons within the scene by applying a face detection process.

Step 30 may be followed by step 32 of searching for linked persons, out of the first plurality of persons, that may be linked to each other, and for unlinked persons, out of the first plurality of persons.

Step 32 may include at least one out of (a) step 36 of searching in databases for social links between the first plurality of persons (for example members of the same family, or persons that appear together in may images may be regarded as linked persons, (b) step 37 of searching for a correlations between movements of the first plurality of persons within the scene (for example families may move together, may stop when the first person stops, and the like), (c) step 38 of searching for persons of the first plurality of persons that entered the scene substantially simultaneously (arrive together), and (d) step 39 of searching linked persons based upon similarities in an appearance of the persons of the first plurality of persons (for example—the same uniforms, the same haircuts).

Step 32 may be executed in various manners—by applying a deep neural network, by applying a machine learning process, by generating signatures of the images, by face recognition algorithms, and the like. An example of a signature generation process and/or object detection is illustrated in U.S. patent application Ser. No. 16/542,327 which is incorporated herein by reference.

Step 10 may also be followed by step 40 of identifying, within the at least one image of the scene, an anchor of a known dimension and a known anchor-to-image sensor distance.

Steps 30 and 40 may be followed by step 50 of estimating, based on the at least one image of the scene, anchor-to-face distances between the anchor and each one of the faces of the first plurality of persons.

Method 100 may also include step 35 of estimating at least one dimension of each of the faces of the first plurality of persons to provide face dimension estimates.

Steps 35 and 50 may be followed by step 60 of determining distances between the first plurality of persons based on the anchor-to-face distances, the face dimension estimates, the known dimension of the anchor and the known anchor-to-image sensor distance.

Step 60 may include step 62 of estimating a location of each face of the first plurality of persons based on a location of the image sensor, the anchor-to-image sensor distance, and the anchor-to-face distance of each face of the first plurality of persons.

Step 60 may be followed by step 70 of determining pandemic avoidance instructions compliance based, at least in part, on the distances.

If a minimal distance should be maintained all time then step 70 determines whether adjacent persons were too close to each other.

If deviations from a minimal distance are allowed for up to predefined periods of time—then distances between adjacent persons as well as the duration of staying in these distances should be monitored. The duration may be determined based on time of acquisition of each of the at least one image.

Step 70 may include step 72 of applying a first determination process on linked persons—for determining pandemic avoidance instructions compliance.

Step 70 may also include step 74 of applying a second determination process on unlinked persons—for determining pandemic avoidance instructions compliance.

The first determination process may differ from the second determination process by at least one rule—for example allowable distance, duration for staying in certain distances, and the like.

The first determination process may be more tolerable to proximity violation of minimal distances between adjacent persons.

For example—the first determination process enable to maintain smaller distances between persons than the second determination process.

Step 70 may be followed by step 80 of responding to the determining.

Step 80 may include at least some of the following steps:
Step 81 of generating one or more alerts when detecting a violation of the pandemic avoidance instructions.
Step 82 of sending an alert to a close or remote entity such as a governmental entity or a private entity. For example sending an alert to a health department, to the police, to a person or organization which controls an access to an asset, alerting vendors, service providers or people located at the vicinity of one or more persons that violated the pandemic avoidance instructions.
Step 83 of requesting a person that violated the pandemic avoidance instructions to cure the violation
Step 84 of performing an access control measure related to the person that violated the pandemic avoidance instructions. The access control measure may include controlling an automatic door by not opening—or closing the automatic door to prevent the person from proceeding through the door. The access control measure may also include informing an entity which manages the access to the asset.
Step 85 of populating one or more database with compliance or violations of pandemic avoidance instructions.
Step 86 of transmitting information regarding compliance or violations of pandemic avoidance instructions.

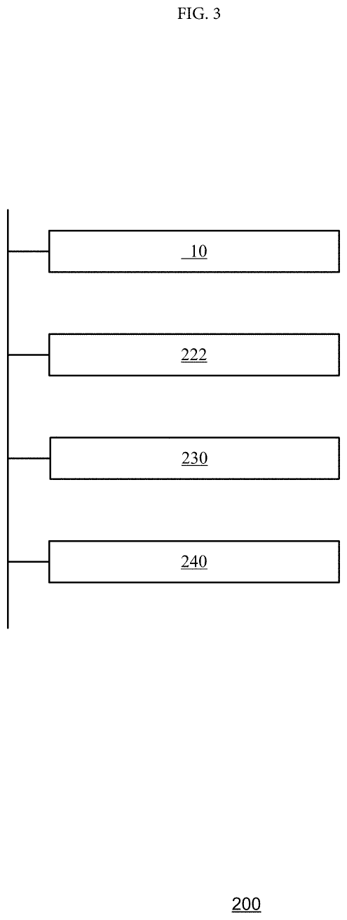

FIG. 3 illustrates an example of a computerized system 200.

Computerized system 200 may include an image acquisition unit 210, a search engine 220, a decision unit 230, and an input output unit 240.

The image acquisition unit 210 is configured to acquire one or more images of the scene. The image acquisition unit may include one or more image sensors and/or may receive one or more images from one or more image sensors not included in the image acquisition unit.

The search engine 220 is configured to detect faces, find one or more anchors. The search engine may also search for linked and unlinked persons.

The decision engine 230 is configured to perform any distance calculation mentioned in at least one of method 10 and method 100. The decision engine 230 may also determine the compliance with pandemic avoidance instructions. The decision engine 230 may also determine how to respond to the determination regarding said compliance.

Each one or image acquisition unit 210, search engine 220 and decision unit 230 may be a computerized unit that may include one or more processing circuit and one or more memory units.

For example—the decision unit 230 may be configured to generate a first alert when the fever information related to the person indicates that the person had fever during the certain time period.

Input output unit 240 may receive and/or output information, and/or alerts and/or reports, and the like. Input output unit 240 may be any suitable communications component such as a network interface card, universal serial bus (USB) port, disk reader, modem or transceiver that may be operative to use protocols such as are known in the art to communicate either directly, or indirectly, with other elements of system 200 and/or other entities.

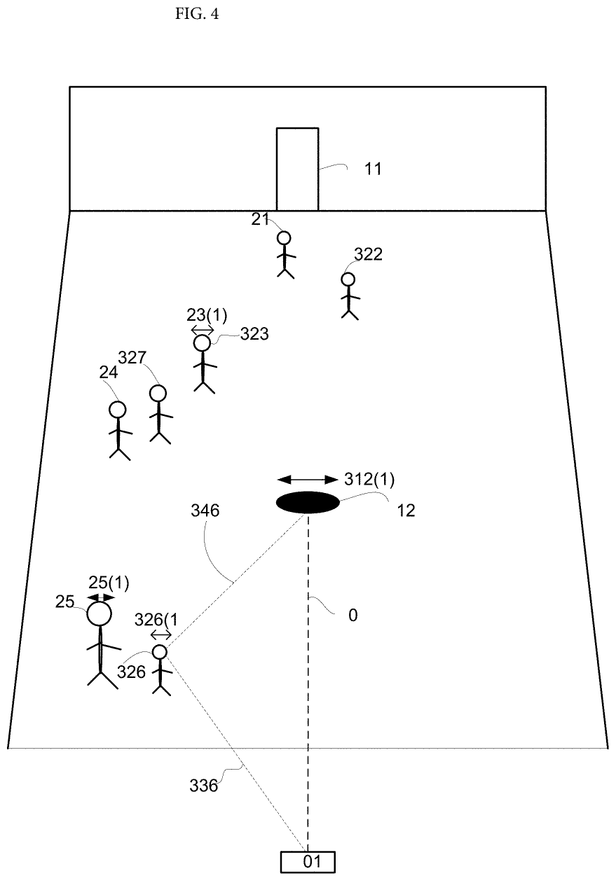

FIGS. 4-7 illustrates an image sensor 301, an image of a scene acquired by the image sensor and different distances and sizes.

The scene includes first till seventh people 321-326. Sixth person 326 is a child while fifth person 325 is an adult. An estimated width of faces of the third, fifth and sixth persons are denoted 323(1), 325(1) and 326(1) respectively.

Anchor 312 is of a known width 312 and is at a known anchor-to-image sensor distance 330 from image sensor 301.

FIG. 4 illustrates an anchor-to-face distance 346 between sixth person and anchor 312, and an estimated distance 336 between the image sensor 301 and the sixth person.

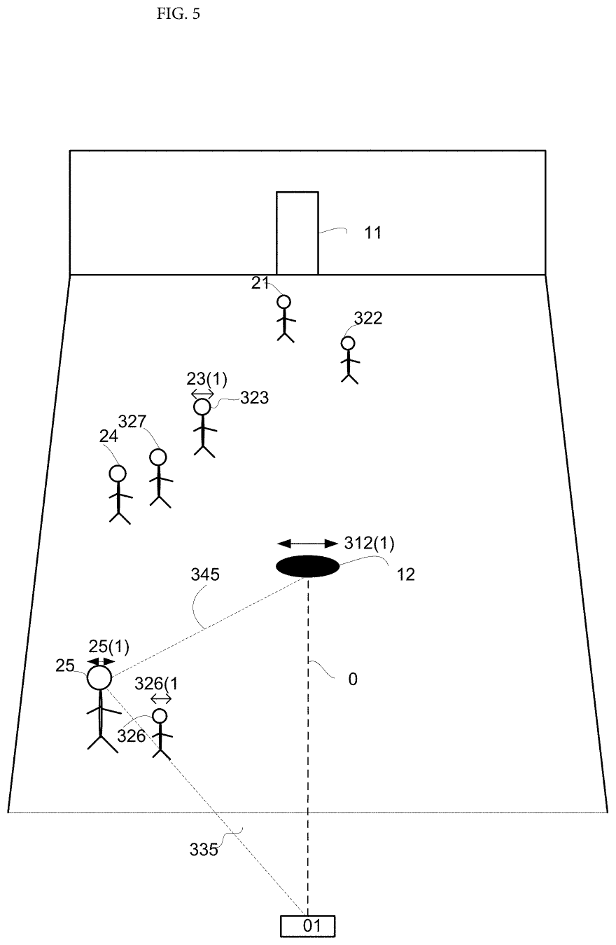

FIG. 5 illustrates an anchor-to-face distance 341 between first person and anchor 312, and an estimated distance 331 between the image sensor 301 and the first person.

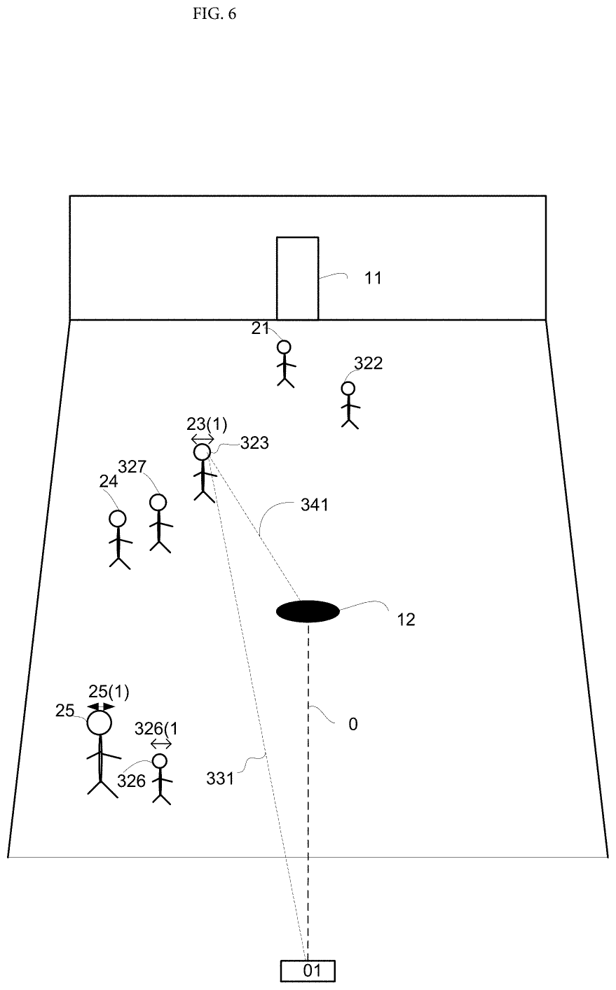

FIG. 6 illustrates distances 352, 353, 355, 356, 357, 258 and 359 between different persons.

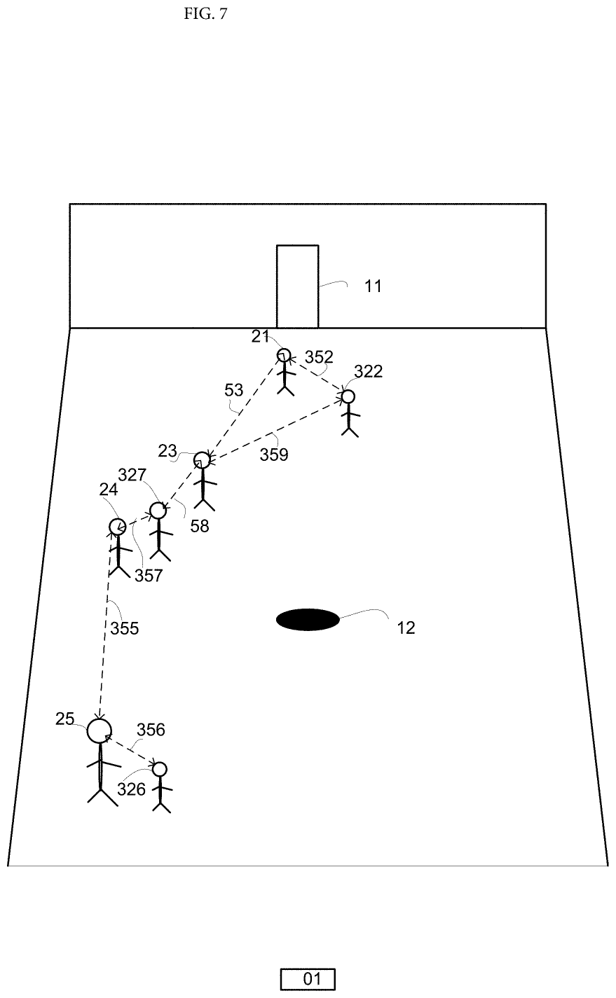

FIG. 7 illustrates different movement patterns of different persons after entering through door 311. This illustrates that fifth and sixth persons walk together and may be regarded as linked people. Other persons may be regarded as unlinked persons based on their movement patterns.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Rather the scope of the embodiments of the disclosure is defined by the appended claims and equivalents thereof.

What is claimed is:

1. A method for face based distance measurements related to pandemic avoidance instructions compliance, the method comprises:
acquiring, by an image sensor, at least one image a scene;
detecting faces of a first plurality of persons within the scene by applying a face detection process;
estimating at least one dimension of each of the faces of the first plurality of persons to provide face dimension estimates;
identifying, within the at least one image of the scene, an anchor of a known dimension and a known anchor-to-image sensor distance;
estimating, based on the at least one image of the scene, anchor-to-face distances between the anchor and each one of the faces of the first plurality of persons;
determining distances between the first plurality of persons based on the anchor-to-face distances, the face dimension estimates, the known dimension of the anchor and the known anchor-to-image sensor distance;
determining Pandemic avoidance instructions compliance based, at least in part, on the distances; and
responding to the determining.

2. The method according to claim 1 wherein the at least one dimension of each of the faces is an area of each of the faces, and the known dimension of the anchor is an area of the anchor.

3. The method according to claim 2 comprising estimating a location of each face of the first plurality of persons based on a location of the image sensor, the anchor-to-image sensor distance, and the anchor-to-face distance of each face of the first plurality of persons.

4. The method according to claim 1 wherein the method comprises searching for linked persons, out of the first plurality of persons, that are linked to each other, and for unlinked persons, out of the first plurality of persons.

5. The method according to claim 4 wherein the determining of the pandemic avoidance instructions compliance comprises applying a first determination process on linked persons and applying a second determination process on unlinked persons, wherein the first determination process differs from the second determination process by at least one rule.

6. The method according to claim 5 wherein the first determination process enable to maintain smaller distances between persons than the second determination process.

7. The method according to claim 4 wherein the searching for linked persons comprises searching in databases for social links between the first plurality of persons.

8. The method according to claim 4 wherein the searching for linked persons comprises searching for a correlations between movements of the first plurality of persons within the scene.

9. The method according to claim 4 wherein the searching for linked persons comprises searching for persons of the first plurality of persons that entered the scene substantially simultaneously.

10. The method according to claim 4 wherein the searching for linked persons based upon similarities in an appearance of the persons of the first plurality of persons.

11. The method according to claim 1 wherein at least one of the estimating of the anchor-to-face distances and the determining of the distances between the first plurality of persons are performed by applying a machine learning process.

12. A non-transitory computer readable medium for face based distance measurements related to pandemic avoidance instructions compliance, the non-transitory computer readable medium stores instructions for
acquiring, by an image sensor, at least one image a scene;
detecting faces of a first plurality of persons within the scene by applying a face detection process;
estimating at least one dimension of each of the faces of the first plurality of persons to provide face dimension estimates;
identifying, within the at least one image of the scene, an anchor of a known dimension and a known anchor-to-image sensor distance;
estimating, based on the at least one image of the scene, anchor-to-face distances between the anchor and each one of the faces of the first plurality of persons;
determining distances between the first plurality of persons based on the anchor-to-face distances, the face dimension estimates, the known dimension of the anchor and the known anchor-to-image sensor distance;
determining Pandemic avoidance instructions compliance based, at least in part, on the distances; and
responding to the determining.

13. The non-transitory computer readable medium according to claim 12 wherein the at least one dimension of each of the faces is an area of each of the faces, and the known dimension of the anchor is an area of the anchor.

14. The non-transitory computer readable medium according to claim 13 the stores instructions for estimating a location of each face of the first plurality of persons based on a location of the image sensor, the anchor-to-image sensor distance, and the anchor-to-face distance of each face of the first plurality of persons.

15. The non-transitory computer readable medium according to claim 12 wherein the method comprises searching for linked persons, out of the first plurality of persons, that are linked to each other, and for unlinked persons, out of the first plurality of persons.

16. The non-transitory computer readable medium according to claim 15 wherein the determining of the pandemic avoidance instructions compliance comprises applying a first determination process on linked persons and applying a second determination process on unlinked persons, wherein the first determination process differs from the second determination process by at least one rule.

17. The non-transitory computer readable medium according to claim 16 wherein the first determination process enable to maintain smaller distances between persons than the second determination process.

18. The non-transitory computer readable medium according to claim 15 wherein the searching for linked persons comprises searching in databases for social links between the first plurality of persons.

19. The non-transitory computer readable medium according to claim 15 wherein the searching for linked persons comprises searching for a correlations between movements of the first plurality of persons within the scene.

20. The non-transitory computer readable medium according to claim 15 wherein the searching for linked persons comprises searching for persons of the first plurality of persons that entered the scene substantially simultaneously.

21. The non-transitory computer readable medium according to claim 15 wherein the searching for linked persons based upon similarities in an appearance of the persons of the first plurality of persons.

22. The non-transitory computer readable medium according to claim 12 wherein at least one of the estimating of the anchor-to-face distances and the determining of the distances between the first plurality of persons are performed by applying a machine learning process.

23. A computerized system that comprises a processor that is configured to execute the method of claim 1.
